(19) United States
(12) Patent Application Publication
(10) Pub. No.: US 2002/0087292 A1
(43) Pub. Date: Jul. 4, 2002

(54) Water enhancement for macrocell and microcell prediction models

(76) Inventors: William C.Y. Lee, Danville, CA (US); Jau Young Lee, San Ramon, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/753,286

(22) Filed: Dec. 29, 2000

Related U.S. Application Data
(60) Provisional application No. 60/232,056, filed on Sep. 12, 2000.

(51) Int. Cl. G06F 17/10

(52) U.S. Cl. 703/2

(57) ABSTRACT

A computer-implemented modeling tool for wireless communications systems predicts signal strength by considering the effects of water on RF signals. The modeling tool creates a model of the RF signals' propagation between a transmitter and a receiver in the wireless communications system. The modeling tool then determines the effect of at least one body of water located between the transmitter and the receiver on the modeled RF signal's propagation. Thereafter, the modeling tool outputs a signal strength value for the modeled RF signal based on the determined effect from the body of water located between the transmitter and receiver.

### BACKGROUND OF THE INVENTION

1. Field of the Invention

The present invention relates to a computer-implemented system for the design and development of wireless communication systems. In particular, the present invention discloses a modeling tool for the design, development and management of wireless communications systems.

2. Description of Related Art

The capacity of a wireless communications system, such as a cellular telephone system, is typically its most precious commodity. Design and management decisions made for wireless communications systems are usually made to maximize the capacity of the system. For example, engineers must design the system to maximize the coverage of the geographic area with the minimum number of cell sites. In addition, interference problems must be studied so that their effect is minimized. Further, the blocking probability of each cell site must be analyzed to ensure proper call initiation.

The design of a wireless communications system is usually performed by using modeling techniques before the system is placed in actual usage. The basic Lee model, described in “Mobile Cellular Telecommunications,” by William C. Y. Lee, Second Edition, 1995, which is incorporated by reference herein, is the standard model for designing cellular telephone systems. The basic Lee model analyzes the propagation of radio frequency (RF) signals under a line-of-sight analysis.

Water presents a unique challenge for modeling the propagation of RF signals in a wireless communications system. It is generally accepted that water enhances radio signals. However, water may many different impacts at varying levels dependant on where a mobile transceiver is located, relative to positions of water and a base station.

Thus, it is necessary to deal with various scenarios in which water plays a critical role in predicting the effect of propagation loss on RF signals. Specifically, enhancements are needed for the basic Lee model in order to handle the unique impact of water on RF signal propagation. The potential impact on the system performance and resources can be drastic.

### SUMMARY OF THE INVENTION

The present invention incorporates additional refinements of the Lee model into a computer-implemented modeling tool that enables designers to more accurately model and design wireless communications systems. The modeling tool predicts signal strength by considering the effects of water on RF signals. The modeling tool creates a model of the RF signals' propagation between a transmitter and a receiver in the wireless communications system. The modeling tool then determines the effect of at least one body of water located between the transmitter and the receiver on the modeled RF signal's propagation. Thereafter, the modeling tool outputs a signal strength value for the modeled RF signal based on the determined effect from the body of water located between the transmitter and receiver.

One object of the present invention is to provide more accurate models for the design of wireless communications systems. Another object of the present invention is to reduce the costs of implementing a wireless communications system.

For a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a hardware and software environment that could be used to implement the preferred embodiment of the present invention.

FIGS. 2-10 illustrate various situations involving transmitters and receivers in a wireless communications system; and

FIGS. 11A and 11B together are a flowchart illustrating the logic performed by the modeling tool according to the preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention is a computer-implemented modeling tool for wireless communications systems that accurately determines the effect of water on RF signal propagation. Specifically, the modeling tool enhances the Lee macrocell and microcell prediction models to take into account the unique impact of water on RF signal propagation. In this regard, the modeling tool uses line-of-sight calculations to determine the signal strength and the effects of water on the signal strength.

This specification first provides an individual case-by-case analysis of the effect water has on RF signal propagation. There are two generalized cases for prediction in the proximity of water: Case 1, where the mobile transceiver is visible to the base station (i.e., has line-of-sight), and Case 2, where the mobile transceiver is blocked from the base station. In each case, a number of possible situations can occur in which water enhances the propagation of RF signals. This specification describes the logic implemented in the modeling tool to handle these different cases.

By considering the actual path that the signal takes between transmitter and receiver, including water reflections, systems designers using the modeling tool of the present invention are able to construct more accurate models of the conditions under which a wireless communications system must operate. This enhanced modeling makes wireless communication systems easier to design and less expensive to implement.

Hardware Environment

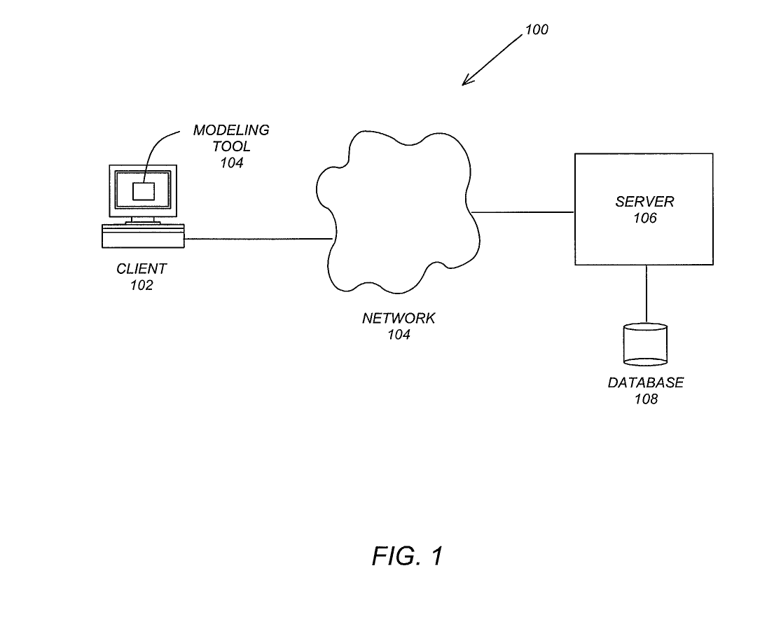

FIG. 1 illustrates a hardware and software environment 100 that could be used to implement the preferred embodiment of the present invention. The environment 100 comprises a client-server architecture, wherein a client computer 102 executes a modeling tool 104 for modeling wireless communications systems. The client computer 102 connects via a network 106 to a server computer 106. The server computer 106 maintains a database 108 that can be used by the modeling tool 104. In this environment 100, a typical combination of resources may include clients 102 that are personal computers or workstations, servers 106 that are personal computers, workstations, minicomputers, or mainframes, and networks 106 that include the Internet, Intranets, LANs, WANs, or the like.

Modeling Tool

The modeling tool 104 generally comprises one or more computer programs executed by the client computer 102. Generally, the modeling tool 104 acts as a “computer-aided drafting system” for modeling wireless communications systems, wherein the wireless communications system includes at least one transmitter and at least one receiver located at a distance from the transmitter. The modeling tool 104 first models a radio frequency (RF) signal's propagation between the transmitter and the receiver, and then determines an effect from at least one body of water residing between the transmitter and the receiver on the modeled RF signal's propagation, wherein the RF signal is represented as a theoretical ray in the computer, and a reflection point of the ray is located where the ray intersects land and water. A signal strength value for the modeled RF signal is outputted based on the determined effect from the body of water residing between the transmitter and receiver.

The modeling tool 104 uses line-of-sight calculations to determine the RF signal's strength and the effect from the body of water on the RF signal's strength. Consequently, the modeling tool 104 predicts the RF signal's propagation in a first case where the receiver is visible to the transmitter and in a second case where the receiver is not visible to the transmitter, if the body of water is detected along a straight-line path from the transmitter to the receiver.

According to the preferred embodiment of the present invention, the modeling tool 104 comprises logic and/or data that is embodied in or retrievable from a device, medium, signal, or carrier, e.g., a data storage device, a data communications device, a remote computer or device coupled to the client computer 102 across the network 106 or via another data communications device, etc. Moreover, this logic and/or data, when read, executed, and/or interpreted, results in the steps necessary to implement and/or use the present invention being performed.

Thus, the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby. Specifically, those skilled in the art will recognize that the present invention may be applied to any database, associated database management system, or peripheral device.

Functions

The modeling tool 104 preferably implements an enhanced version of the Lee model described above. This enhanced version of the Lee model represents an RF signal as a theoretical ray, wherein a reflection point of that ray is obtained by inverting a mobile transceiver about the land (and/or water, if a body of water exists between a base station and the mobile transceiver), and then connecting the inverted mobile transceiver with the base station by a line (i.e., a ray). The reflection point is located where the ray intersects the land and/or water. The reflected ray is then connected, by a straight line, from the reflection point to the “original” mobile transceiver antenna. The prediction is affected if water is detected along the straight-line path from the base station to the mobile transceiver. That includes the case in which the mobile transceiver itself is located on water.

Inputs

The following are the input parameters required by the modeling tool 104 for use in the enhanced Lee model according to the preferred embodiment of the present invention:

D=Distance between the base station and the mobile transceiver [in feet].

Radial Land elevation=All the points between the base station and the mobile transceiver [in feet].

Radial Attribute elevation=All the points between the base station and the mobile transceiver [in feet].

MoHt=Mobile transceiver antenna height (is equivalent to 5 ft.).

TxHt=Base station antenna height+AMSL (Average Mean Sea Level) [in feet].

HtAGL=Base station antenna elevation above ground level [in feet].

OAL=Open Area Loss=−49−43.5*log₁₀ (D in feet/5280) [in dBm].

FSL=Free Space Loss=46.0−95.2−20*log₁₀ (D in feet/5280) [in dBm].

Shadow Loss=[in dBm].

The OAL includes a slope loss of 43.5 dB/decade and a one-mile intercept of −49 dBm. Those values were derived from empirical measurements conducted in many cities. See, e.g., Lee, W. C. Y., “Mobile Communication Engineering”, McGraw Hill, 1982, pp. 112-142, which is incorporated by reference herein.

The FSL contains a hard coded base station power and a signal attenuation figure. The 46 dBm is the transmitted base station total ERP (effective radiated power), which comprises antenna output power and gain, and is equivalent to Pₜ (transmitter power) in the following publication: Lee, W. C. Y., “Mobile Cellular Telecommunication System, Analog & Digital”, McGraw Hill, 1995, p. 146, which is incorporated by reference herein. The −95.2−20*log₁₀ (D/5280) is equivalent to the denominator of 4πdλ² when calculated in log base 10 and d is in feet. The FSL is used to calculate the attenuation of an RF signal in free space and therefore, in theory, comprises 20 dB/decade.

The Shadow Loss is that loss due to knife-edge diffraction around obstacles. See, e.g., W. C. Y. Lee and David J. Y. Lee, “Handoff Effects on Cellular CDMA System”, 2nd International Conference on Personal, Mobile and Spread Spectrum Communications, which publication is incorporated by reference herein.

Outputs

The following is the output parameter generated by the modeling tool 104 in calculating water enhancements:

Signal=Received signal strength [in dBm]

Examples Where the Mobile Transceiver is Visible

Case 1: Mobile Transceiver Is Visible

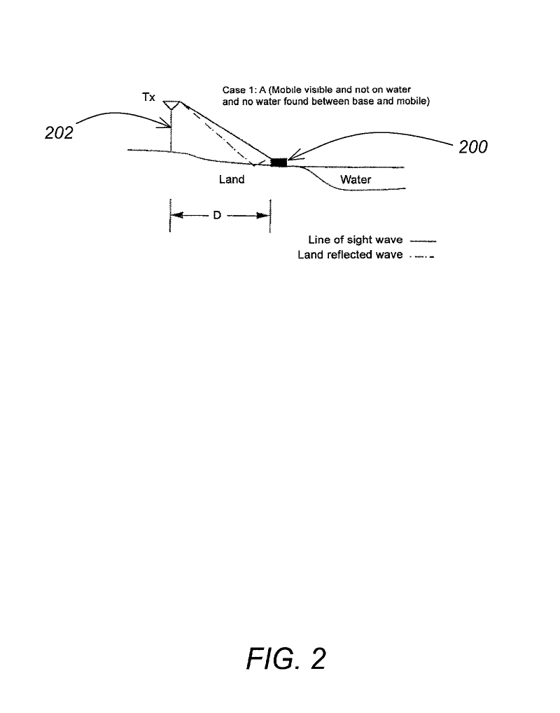

(A) As shown in FIG. 2, the mobile transceiver 200 is visible to the base station 202 (the antenna labeled Tx), is not on the water, and there is no water between the base station 202 and the mobile transceiver 200. Since water is not detected along the straight line between the base station 202 and mobile transceiver 200, there are no water-reflected RF signals. Consequently, the line-of-sight and reflected wave parameters are the only parameters considered in the Lee model. This case is known as the “two ray model.”

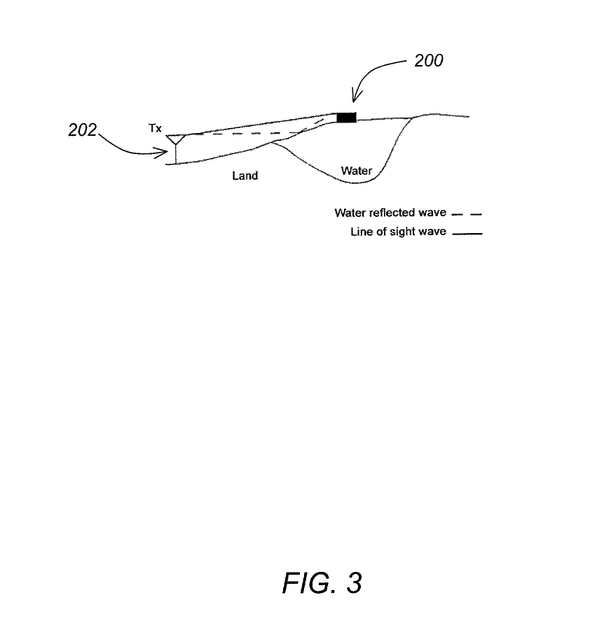

(B) As shown in FIG. 3, the mobile transceiver 200 is visible to the base station 202, and is on the water. The logic for this situation is provided below:

if TxHt<=MoHt

then Signal=OAL+6 dB

if Signal>FSL

then Signal=FSL

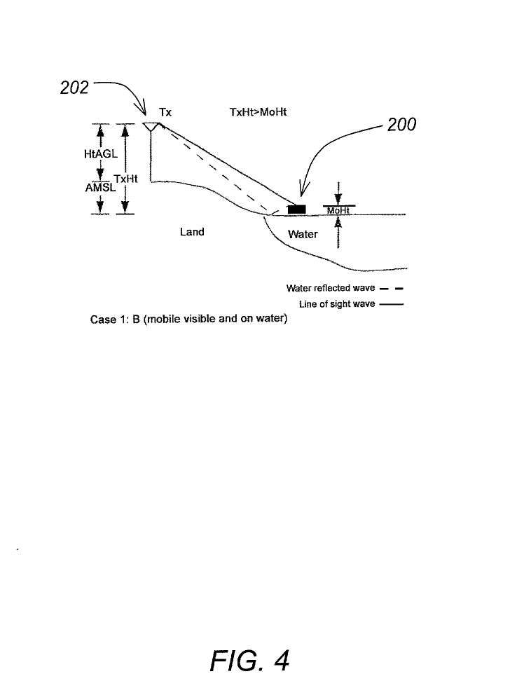

(C) As shown in FIG. 4, the mobile transceiver 200 is visible to the base station 202, and is on the water. The OAL is generally used when a mobile transceiver 200 is on water because of the absence of obstacles that can cause scattering, which is similar to an open area effect. The logic for this situation is provided below:

if TxHt>MoHt

then Signal=OAL+20 log (TxHt−MoHt/HtAGL)=OAL+effective antenna height gain

if Signal>FSL

then Signal=FSL

The height of the antenna 202 is 100 feet and then scaled appropriately.

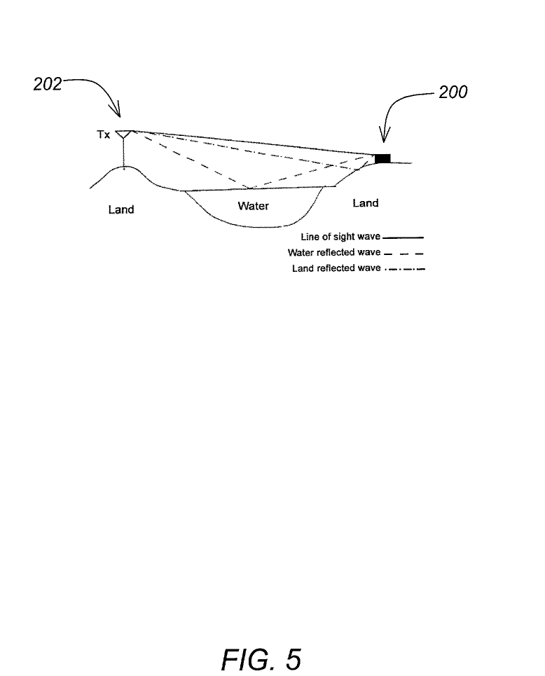

(D) As shown in FIG. 5, the mobile transceiver 200 is visible to the base station 202, there is water between the mobile transceiver 200 and the base station 202, and the mobile transceiver 200 is on the land. A 3-ray model is used when water is detected.

if both land-reflected and water-reflected RF signals are not blocked then Signal=46−20 log (4πD/1.16)

In the above equation, D is the distance between the base station 202 and the mobile transceiver 200, and 1.16 is the wavelength in feet of the RF signals at 850 MHz. Those skilled in the art will recognize that other wavelengths could be used, so long as the correct values are substituted for 1.16.

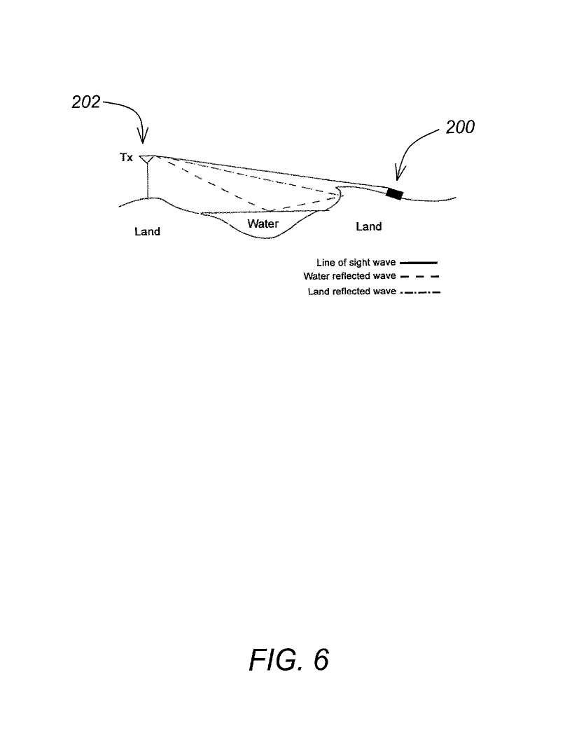

(E) As shown in FIG. 6, the mobile transceiver 200 is visible to the base station 202, there is water between the mobile transceiver 200 and the base station 202, and the land and water are blocked from the mobile transceiver 200. The logic for this situation is provided below:

if both land-reflected and water-reflected RF signals are blocked then:

1. Find Shadow Loss for point that blocks mobile transceiver 200 from land.

2. Signal=Path Loss+Shadow Loss

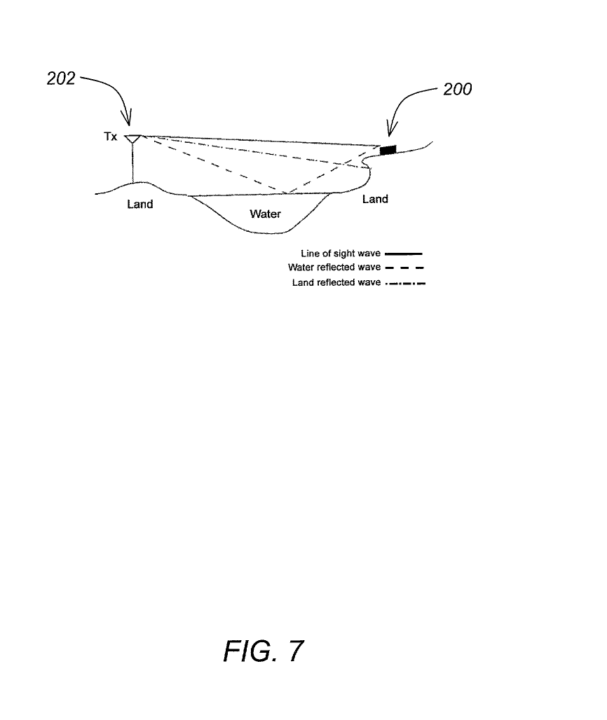

(F) As shown in FIG. 7, the mobile transceiver 200 is visible to the base station 202, there is water between the mobile transceiver 200 and the base station 202, the land is blocked from the mobile transceiver 200, and the water is not blocked from the mobile transceiver 200. A 2-ray model is used because the RF signal reflected by the water is not blocked from the mobile transceiver 200. The logic for this situation is provided below:

if land-reflected RF signals are blocked and water-reflected RF signals are not blocked then use the basic Lee model

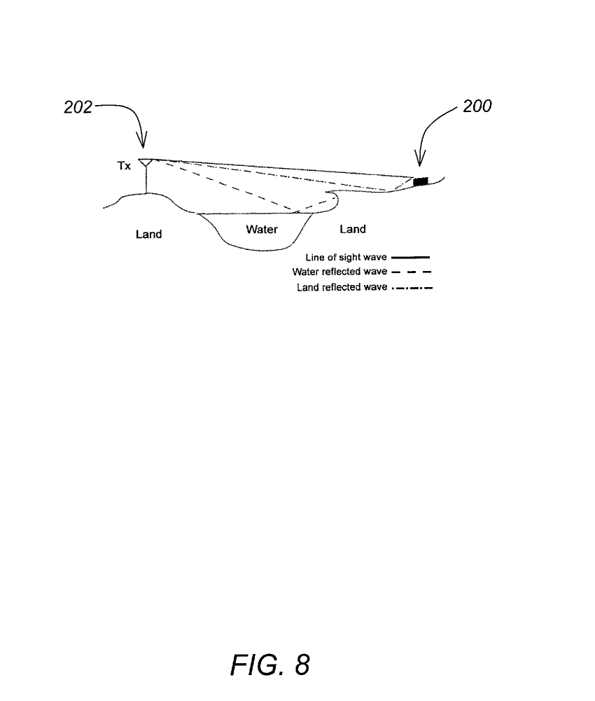

(G) As shown in FIG. 8, the mobile transceiver 200 is visible to the base station 202, there is water between the mobile transceiver 200 and the base station 202, the land is not blocked from the mobile transceiver 200, and the water is blocked from the mobile transceiver 200. A 2-ray model is used because the RF signal reflected by the water is blocked from the mobile transceiver 200, but the RF signal reflected by the land is not blocked from the mobile transceiver 200. The logic for this situation is provided below:

if land-reflected RF signals are not blocked and water-reflected RF signals are blocked then use the basic Lee model

Examples Where The Mobile Transceiver Is Not Visible

Case 2: Mobile Transceiver Is Not Visible

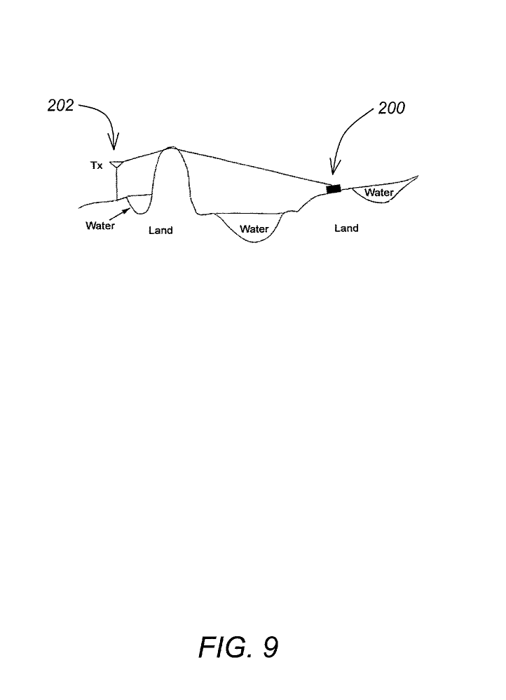

(A) As shown in FIG. 9, the mobile transceiver 200 is not visible to the base station 202, is not on the water, and there is both water and land between the base station 202 and the mobile transceiver 200. In this situation, knife-edge diffraction occurs.

if both land-reflected and water-reflected RF signals are blocked then use the basic Lee model

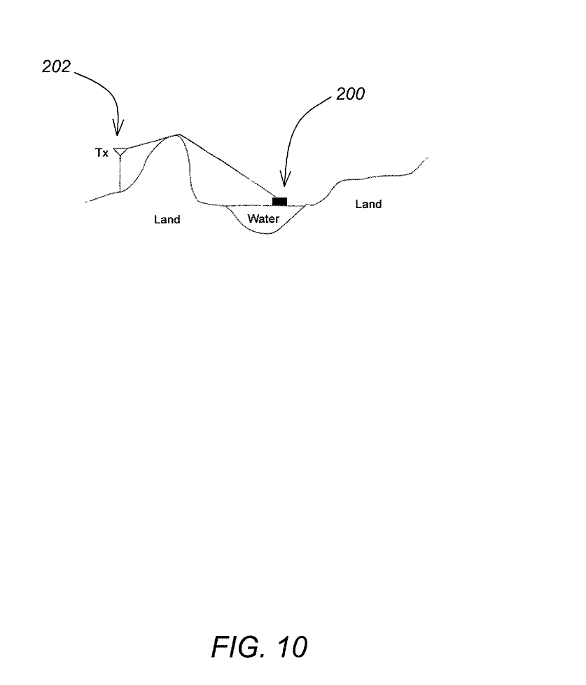

(B) As shown in FIG. 10, the mobile transceiver 200 is not visible to the base station 202, is on the water, and there is both water and land between the base station 202 and the mobile transceiver 200. The lack of obstacles is used for selecting the OAL. The logic for this situation is provided below:

1. Calculate the Shadow Loss

2. Signal=OAL+Shadow Loss

Logic of the Modeling Tool

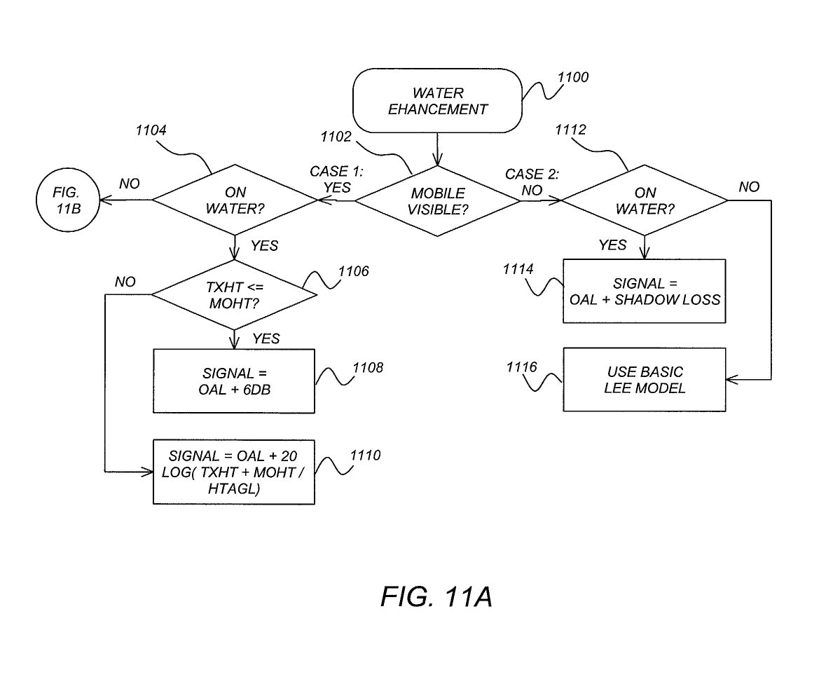

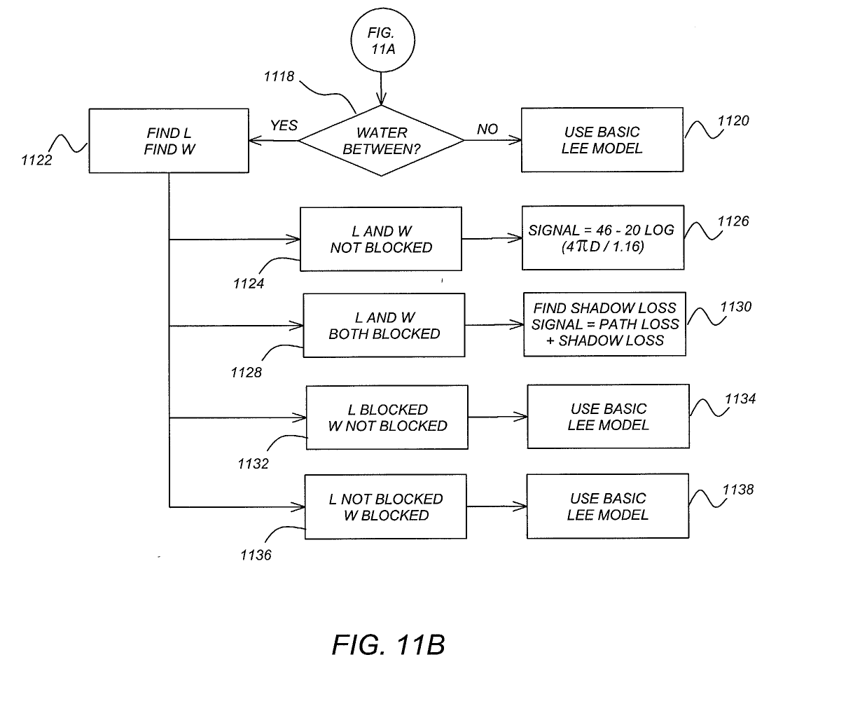

FIGS. 11A and 11B together are a flowchart illustrating the logic performed by the modeling tool 104 according to the preferred embodiment of the present invention.

Referring to FIG. 11A, Block 1100 represents the beginning of the logic.

Block 1102 is a decision block that represents the modeling tool 104 determining whether the mobile transceiver 200 is line-of-sight visible to the base station 202. If so, control transfers to Block 1104 (Case 1); otherwise, control transfers to Block 1112 (Case 2).

Block 1104 is a decision block that that represents the modeling tool 104 determining whether the mobile transceiver 200 is on a body of water. If so, control transfers to Block 1106; otherwise, control transfers to Block 1118 in FIG. 11B.

Block 1106 is a decision block that that represents the modeling tool 104 determining whether TxHt<=MoHt, i.e., the base station 202 antenna height above average mean sea level is less than or equal to the mobile transceiver 200 antenna height. If so, control transfers to Block 1108; otherwise, control transfers to Block 1110.

Block 1108 represents the modeling tool 104 calculating the signal strength according to the following:

Signal=OAL+6 dB

Block 1110 represents the modeling tool 104 calculating the signal strength according to the following:

Signal=OAL+20 log (TxHt−MoHt/HtAGL)

Block 1112 is a decision block that represents the modeling tool 104 determining whether the mobile transceiver 200 is on a body of water. If so, control transfers to Block 1114; otherwise, control transfers to Block 1116.

Block 1114 represents the modeling tool 104 calculating the signal strength according to the following:

Signal=OAL+Shadow Loss

Block 1116 represents the modeling tool 104 calculating the signal strength using the basic Lee model.

Referring to FIG. 11B, Block 1118 is a decision block that determines whether there is a body of water between the base station 202 and the mobile transceiver 200. If not, control transfers to Block 1120; otherwise, control transfers to Block 1122.

Block 1120 represents the modeling tool 104 calculating the signal strength using the basic Lee model.

Block 1122 represents the modeling tool 104 determining the paths of a reflected land wave L and a reflected water wave W. Thereafter, Blocks 1124-1138 comprise a CASE statement, wherein 1124-1126, 1128-1130, 1132-1134, or 1136-1138 are selected based on whether L and W are blocked from a line-of-sight view of the mobile transceiver 200.

Block 1124 represents the modeling tool 104 determining that neither the reflected land wave L and the reflected water wave W are blocked, and Block 1126 represents the modeling tool 104 calculating the signal strength according to the following:

Signal=46−20 log (4πD/1.16)

wherein D is the distance between the base station 202 and the mobile transceiver 200, and 1.16 is the wavelength in feet of an 850 MHz signal. Those skilled in the art will recognize that other wavelengths could be used, so long as the correct values are substituted for 1.16.

Block 1128 represents the modeling tool 104 determining that both the reflected land wave L and the reflected water wave W are blocked, and Block 1130 represents the modeling tool 104 calculating the signal strength according to the following:

1. Find Shadow Loss for the point that blocks the mobile transceiver from L, and

2. Signal=Path Loss+Shadow Loss

Block 1132 represents the modeling tool 104 determining that the reflected land wave L is blocked and the reflected water wave W is not blocked, and Block 1134 represents the modeling tool 104 calculating the signal strength using the basic Lee model.

Block 1136 represents the modeling tool 104 determining that the reflected land wave L is not blocked and the reflected water wave W is blocked, and Block 1138 represents the modeling tool 104 calculating the signal strength using the basic Lee model.

Conclusion

This concludes the description of the preferred embodiment of the invention. The following paragraphs describe some alternative embodiments for accomplishing the same invention.

In an alternative embodiment, any type of computer could be used to implement the present invention. In addition, any type of computer program that performs similar functions could be used with the present invention.

Although this specification and the associated drawings describe the mobile transceiver 200 as a “receiver” and the base station 202 as a “transmitter,” those skilled in the art will recognize that these roles could be reversed. Indeed, in normal usage, the mobile transceiver and the base station perform as both a “receiver” as well as a “transmitter.”

In an alternative embodiment, any type of transmitters and receivers could be used with the present invention. Specifically, the transmitters and receivers do not need to be characterized as base stations and mobile transceivers.

In summary, the present invention discloses A computer-implemented modeling tool for wireless communications systems predicts signal strength by considering the effects of water on RF signals. The modeling tool creates a model of the RF signals' propagation between a transmitter and a receiver in the wireless communications system. The modeling tool then determines the effect of at least one body of water located between the transmitter and the receiver on the modeled RF signal's propagation. Thereafter, the modeling tool outputs a signal strength value for the modeled RF signal based on the determined effect from the body of water located between the transmitter and receiver.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for modeling a wireless communications system, wherein the wireless communications system includes at least one transmitter and at least one receiver located at a distance from the transmitter, the method comprising:
(a) modeling, in the computer, a radio frequency (RF) signal's propagation between the transmitter and the receiver;
(b) determining, in the computer, an effect from at least one body of water residing between the transmitter and the receiver on the modeled radio frequency (RF) signal's propagation; and
(c) outputting, from the computer, a signal strength value for the modeled RF signal based on the determined effect from the body of water residing between the transmitter and receiver.

2. The method of claim 1, wherein the determining step comprises using line-of-sight calculations to determine the RF signal's strength and the effect from the body of water on the RF signal's strength.

3. The method of claim 1, wherein the RF signal is represented as a theoretical ray in the computer, and a reflection point of the ray is located where the ray intersects land and water.

4. The method of claim 1, wherein the determining step comprises predicting the RF signal's propagation in a first case where the receiver is visible to the transmitter.

5. The method of claim 4, wherein the predicting step is affected if the body of water is detected along a straight-line path from the transmitter to the receiver.

6. The method of claim 1, wherein the determining step comprises predicting the RF signal's propagation in a second case where the receiver is not visible to the transmitter.

7. The method of claim 6, wherein the predicting step is affected if the body of water is detected along a straight-line path from the transmitter to the receiver.

8. The method of claim 1, wherein the determining step comprises:
if the receiver is line-of-sight visible to the transmitter, the receiver is on the body of water, and the transmitted's antenna height above average mean sea level is less than or equal to the receiver's antenna height, then calculating the signal strength according to the following:
Signal=OAL+6 dB
wherein OAL is an Open Area Loss:
OAL=−49−43.5*log₁₀ (D in feet/5280)
and D is a distance between the transmitter and the receiver.

9. The method of claim 1, wherein the determining step comprises:
if the receiver is line-of-sight visible to the transmitter, the receiver is on the body of water, and the transmitter's antenna height above average mean sea level is greater than the receiver's antenna height, then calculating the signal strength according to the following:
Signal=OAL+20 log (TxHt−MoHt/HtAGL)
wherein OAL is an Open Area Loss:
OAL=−49−43.5*log₁₀ (D in feet/5280)
TxHt is the transmitter's antenna height above average mean sea level, MoHt is the receiver's antenna height, and HtAGL is the transmitter's antenna elevation above ground level, and D is a distance between the transmitter and the receiver.

10. The method of claim 1, wherein the determining step comprises:
if the receiver is not line-of-sight visible to the transmitter, and the receiver is on the body of water, then calculating the signal strength according to the following:
Signal=OAL+Shadow Loss
wherein OAL is an Open Area Loss:
OAL=−49−43.5*log₁₀ (D in feet/5280)
D is a distance between the transmitter and the receiver, and the Shadow Loss is a loss due to knife-edge diffraction around obstacles.

11. The method of claim 1, wherein the determining step comprises:
if the receiver is not line-of-sight visible to the transmitter, and the receiver is on the body of water, then calculating the signal strength according to a basic Lee model.

12. The method of claim 1, wherein the determining step comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are not blocked, then calculating the signal strength according to the following:
Signal=46−20 log (4πD/W)
wherein D is a distance between the transmitter and the receiver, and W is a wavelength of the RF signal.

13. The method of claim 1, wherein the determining step comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are both blocked from the receiver, then calculating the signal strength according to the following:
(i) find Shadow Loss for a point that blocks the receiver from the RF signals reflected by land, and
(ii) Signal=Path Loss+Shadow Loss
wherein the Shadow Loss is that loss due to knife-edge diffraction around obstacles.

14. The method of claim 1, wherein the determining step comprises:
if the receiver is line-of-sight visible to the transmitter, the receiver is not on the body of water, the body of water is located between the transmitter and the receiver, and the paths of the RF signals reflected by land are blocked from the receiver and the paths of the RF signals reflected by the body of water are not blocked from the receiver, then calculating the signal strength using the basic Lee model.

15. The method of claim 1, wherein the determining step comprises:
if the receiver is line-of-sight visible to the transmitter, the receiver is not on the body of water, the body of water is located between the transmitter and the receiver, and the paths of the RF signals reflected by land are not blocked from the receiver and the paths of the RF signals reflected by the body of water are blocked from the receiver, then calculating the signal strength using a basic Lee model.

16. An article of manufacture embodying logic for modeling a wireless communications system, wherein the wireless communications system includes at least one transmitter and at least one receiver located at a distance from the transmitter, the logic comprising:
(a) modeling, in a computer, a radio frequency (RF) signal's propagation between the transmitter and the receiver;
(b) determining, in the computer, an effect from at least one body of water residing between the transmitter and the receiver on the modeled radio frequency (RF) signal's propagation; and
(c) outputting, from the computer, a signal strength value for the modeled RF signal based on the determined effect from the body of water residing between the transmitter and receiver.

17. The article of manufacture of claim 16, wherein the determining step comprises using line-of-sight calculations to determine the RF signal's strength and the effect from the body of water on the RF signal's strength.

18. The article of manufacture of claim 16, wherein the RF signal is represented as a theoretical ray in the computer, and a reflection point of the ray is located where the ray intersects land and water.

19. The article of manufacture of claim 16, wherein the determining step comprises predicting the RF signal's propagation in a first case where the receiver is visible to the transmitter.

20. The article of manufacture of claim 19, wherein the predicting step is affected if the body of water is detected along a straight-line path from the transmitter to the receiver.

21. The article of manufacture of claim 16, wherein the determining step comprises predicting the RF signal's propagation in a second case where the receiver is not visible to the transmitter.

22. The article of manufacture of claim 21, wherein the predicting step is affected if the body of water is detected along a straight-line path from the transmitter to the receiver.

23. The article of manufacture of claim 16, wherein the determining step comprises:
if the receiver is line-of-sight visible to the transmitter, the receiver is on the body of water, and the transmitter's antenna height above average mean sea level is less than or equal to the receiver's antenna height, then calculating the signal strength according to the following:
Signal=OAL+6 dB
wherein OAL is an Open Area Loss:
OAL=−49−43.5*log₁₀ (D in feet/5280)
and D is a distance between the transmitter and the receiver.

24. The article of manufacture of claim 16, wherein the determining step comprises:
if the receiver is line-of-sight visible to the transmitter, the receiver is on the body of water, and the transmitter's antenna height above average mean sea level is greater than the receiver's antenna height, then calculating the signal strength according to the following:
Signal=OAL+20 log (TxHt−MoHt/HtAGL)
wherein OAL is an Open Area Loss:
OAL=−49−43.5*log₁₀ (D in feet/5280)
TxHt is the transmitter's antenna height above average mean sea level, MoHt is the receiver's antenna height, and HtAGL is the transmitter's antenna elevation above ground level, and D is a distance between the transmitter and the receiver.

25. The article of manufacture of claim 16, wherein the determining step comprises:
if the receiver is not line-of-sight visible to the transmitter, and the receiver is on the body of water, then calculating the signal strength according to the following:
Signal=OAL+Shadow Loss
wherein OAL is an Open Area Loss:
OAL=−49−43.5*log₁₀ (D in feet/5280)
D is a distance between the transmitter and the receiver, and the Shadow Loss is a loss due to knife-edge diffraction around obstacles.

26. The article of manufacture of claim 16, wherein the determining step comprises:
if the receiver is not line-of-sight visible to the transmitter, and the receiver is on the body of water, then calculating the signal strength according to a basic Lee model.

27. The article of manufacture of claim 16, wherein the determining step comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are not blocked, then calculating the signal strength according to the following:
Signal=46−20 log(4πD/W)
wherein D is a distance between the transmitter and the receiver, and W is a wavelength of the RF signal.

28. The article of manufacture of claim 16, wherein the determining step comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are both blocked from the receiver, then calculating the signal strength according to the following:
(i) find Shadow Loss for a point that blocks the receiver from the RF signals reflected by land, and
(ii) Signal=Path Loss+Shadow Loss
wherein the Shadow Loss is that loss due to knife-edge diffraction around obstacles.

29. The article of manufacture of claim 16, wherein the determining step comprises:
if the receiver is line-of-sight visible to the transmitter, the receiver is not on the body of water, the body of water is located between the transmitter and the receiver, and the paths of the RF signals reflected by land are blocked from the receiver and the paths of the RF signals reflected by the body of water are not blocked from the receiver, then calculating the signal strength using the basic Lee model.

30. The article of manufacture of claim 16, wherein the determining step comprises:
if the receiver is line-of-sight visible to the transmitter, the receiver is not on the body of water, the body of water is located between the transmitter and the receiver, and the paths of the RF signals reflected by land are not blocked from the receiver and the paths of the RF signals reflected by the body of water are blocked from the receiver, then calculating the signal strength using a basic Lee model.

31. A computer-implemented system for modeling a wireless communications system, wherein the wireless communications system includes at least one transmitter and at least one receiver located at a distance from the transmitter, comprising:
(a) a computer;
(b) means, performed by the computer, for modeling a radio frequency (RF) signal's propagation between the transmitter and the receiver;
(c) means, performed by the computer, for determining an effect from at least one body of water residing between the transmitter and the receiver on the modeled radio frequency (RF) signal's propagation; and
(d) means, performed by the computer, for outputting a signal strength value for the modeled RF signal based on the determined effect from the body of water residing between the transmitter and receiver.

32. The system of claim 31, wherein the means for determining comprises means for using line-of-sight calculations to determine the RF signal's strength and the effect from the body of water on the RF signal's strength.

33. The system of claim 31, wherein the RF signal is represented as a theoretical ray in the computer, and a reflection point of the ray is located where the ray intersects land and water.

34. The system of claim 31, wherein the means for determining comprises means for predicting the RF signal's propagation in a first case where the receiver is visible to the transmitter.

35. The system of claim 34, wherein the means for predicting is affected if the body of water is detected along a straight-line path from the transmitter to the receiver.

36. The system of claim 31, wherein the means for determining comprises means for predicting the RF signal's propagation in a second case where the receiver is not visible to the transmitter.

37. The system of claim 36, wherein the means for predicting is affected if the body of water is detected along a straight-line path from the transmitter to the receiver.

38. The system of claim 31, wherein the means for determining comprises:
if the receiver is line-of-sight visible to the transmitter, the receiver is on the body of water, and the transmitter's antenna height above average mean sea level is less than or equal to the receiver's antenna height, then calculating the signal strength according to the following:
Signal=OAL+6 dB
wherein OAL is an Open Area Loss:
OAL=−49−43.5*log₁₀ (D in feet/5280)
and D is a distance between the transmitter and the receiver.

39. The system of claim 31, wherein the means for determining comprises:
if the receiver is line-of-sight visible to the transmitter, the receiver is on the body of water, and the transmitter's antenna height above average mean sea level is greater than the receiver's antenna height, then calculating the signal strength according to the following:
Signal=OAL+20 log(TxHt−MoHt/HtAGL)
wherein OAL is an Open Area Loss:
OAL=−49−43.5*log₁₀ (D in feet/5280)
TxHt is the transmitter's antenna height above average mean sea level, MoHt is the receiver's antenna height, and HtAGL is the transmitter's antenna elevation above ground level, and D is a distance between the transmitter and the receiver.

40. The system of claim 31, wherein the means for determining comprises:
if the receiver is not line-of-sight visible to the transmitter, and the receiver is on the body of water, then calculating the signal strength according to the following:
Signal=OAL+Shadow Loss
wherein OAL is an Open Area Loss:
OAL=−49−43.5*log₁₀ (D in feet/5280)
D is a distance between the transmitter and the receiver, and the Shadow Loss is a loss due to knife-edge diffraction around obstacles.

41. The system of claim 31, wherein the means for determining comprises:
if the receiver is not line-of-sight visible to the transmitter, and the receiver is on the body of water, then calculating the signal strength according to a basic Lee model.

42. The system of claim 31, wherein the means for determining comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are not blocked, then calculating the signal strength according to the following:
Signal=46−20 log(4πD/W)
wherein D is a distance between the transmitter and the receiver, and W is a wavelength of the RF signal.

43. The system of claim 31, wherein the means for determining comprises:
if the receiver is line-of-sight visible to the transmitter, the receiver is not on the body of water, the body of water is located between the transmitter and the receiver, and the paths of the RF signals reflected by land and the paths of the RF signals reflected by the body of water are both blocked from the receiver, then calculating the signal strength according to the following:
(i) find Shadow Loss for a point that blocks the receiver from the RF signals reflected by land, and
(ii) Signal=Path Loss+Shadow Loss
wherein the Shadow Loss is that loss due to knife-edge diffraction around obstacles.

44. The system of claim 31, wherein the means for determining comprises:
if the receiver is line-of-sight visible to the transmitter, the receiver is not on the body of water, the body of water is located between the transmitter and the receiver, and the paths of the RF signals reflected by land are blocked from the receiver and the paths of the RF signals reflected by the body of water are not blocked from the receiver, then calculating the signal strength using the basic Lee model.

45. The system of claim 31, wherein the means for determining comprises:
if the receiver is line-of-sight visible to the transmitter, the receiver is not on the body of water, the body of water is located between the transmitter and the receiver, and the paths of the RF signals reflected by land are not blocked from the receiver and the paths of the RF signals reflected by the body of water are blocked from the receiver, then calculating the signal strength using a basic Lee model.
